(19) United States
(12) Patent Application Publication
(10) Pub. No.: US 2016/0285372 A1
(43) Pub. Date: Sep. 29, 2016

(54) POWER DRIVING DEVICE AND SEMICONDUCTOR DEVICE INCLUDING THE SAME

(71) Applicant: SK hynix Inc., Icheon-si Gyeonggi-do (KR)

(72) Inventor: Mun Seon JANG, Seoul (KR)

(21) Appl. No.: 14/810,925

(22) Filed: Jul. 28, 2015

(30) Foreign Application Priority Data
Mar. 27, 2015 (KR) 10-2015-0043258

(51) Int. Cl. H02M 3/158

(52) U.S. Cl. CPC H02M 3/158

(57) ABSTRACT

A power driving circuit including a voltage generation unit configured to generate a release control signal and an output voltage. The power driving circuit including a release controller configured to enable a release signal during an activation section of a flag signal in response to the release control signal. The power driving circuit including a pull-up driving unit configured to increase a level of the output voltage in response to the release control signal. The power driving circuit including a release driving unit configured to synchronize a level of the output voltage in response to the release signal.

### CROSS-REFERENCE TO RELATED APPLICATION

This application claims priority based upon Korean patent application No. 10-2015-0043258, filed on Mar. 27, 2015, the disclosure of which is hereby incorporated in its entirety by reference herein.

### BACKGROUND

1. Technical Field

Various embodiments generally relate to a power driving circuit and a semiconductor device including the same, and more particularly, to a technology for reducing current consumption of a voltage driving circuit.

2. Related Art

If the integration degree of a Dynamic Random Access Memory (DRAM) increases and a high voltage is used as an external power-supply voltage, reliability of the DRAM's transistors may deteriorate. In order to address this issue, a voltage conversion circuit for reducing a power-supply voltage within a chip has been widely used. In the case of using a lower power-supply voltage, power consumption can be reduced. If a constant voltage is established as an internal voltage source, the stable power-supply voltage can be guaranteed even when the external power-supply voltage is changed, resulting in stable operation of the chip.

However, load of a peripheral circuit or memory array configured to receive an internal voltage (VINT) may be excessively changed, so that it may be difficult to design a circuit that can perform stable operations within a DRAM.

A core of the DRAM includes a cell, a sub word line driver, a sense amplifier, an X-decoder, and a Y-decoder. In this case, a core voltage (VCORE) acting as a constant-potential voltage and a high voltage (VPP) may be used as an internal voltage (VINT) for use within a core.

For example, the core voltage (VCORE) is less than an external power-supply voltage (VDD), and the high voltage (VPP) is higher than the external power-supply voltage (VDD). During the active operation of DRAM, the core voltage (VCORE) is used, resulting in a large amount of current consumption. Therefore, the core voltage (VCORE) is generated by an active driver for generating the internal voltage using an operational amplifier. There are various types of power-supply voltages generated in a single chip. When one power-supply voltage is switched to another power-supply voltage, an inflow of a current becomes vulnerable, so that a release circuit may be used in response. If a power-supply level increases due to the inflow of a current, the release circuit may prevent an internal voltage level from increasing to a desired target level or higher.

That is, a voltage generation circuit continuously receives a current from the external power-supply voltage (VDD) to adjust its own core voltage target level, and the release circuit continuously emits a current to reduce the increased core voltage (VCORE). However, the voltage generation circuit and the release circuit are configured to perform a complementary operation through feedback at a time point at which the internal voltage reaches a desired target level, resulting in high current consumption.

### SUMMARY

According to an embodiment, there may be provided a power driving circuit. The power driving circuit may include a voltage generation unit configured to generate a release control signal and a output voltage. The power driving circuit may include a release controller configured to enable a release signal during an activation section of a flag signal in response to the release control signal. The power driving circuit may include a pull-up driving unit configured to increase a level of the output voltage in response to the release control signal. The power driving circuit may include a release driving unit configured to synchronize a level of the output voltage in response to the release signal.

According to an embodiment, there may be provided a semiconductor device. The semiconductor device may include a power driving circuit configured to generate a core voltage in response to a power-supply voltage level, and synchronize the core voltage in response to a release signal activated during an activation time of a flag signal. The semiconductor device may include a power line driving unit configured to selectively supply the power-supply voltage or the core voltage to a first power line in response to a drive signal, and supply a ground voltage to a second power line. The semiconductor device may include a bit line sense amplifier coupled to the first power line and the second power line, and may be configured to amplify cell data received from a bit line.

### BRIEF DESCRIPTION OF THE DRAWINGS

FIG. 1 is a block diagram illustrating a representation of an example of a semiconductor device to which a power driving circuit is applied according to an embodiment.

FIG. 2 is a circuit diagram illustrating a representation of an example of a power line driving unit illustrated in FIG. 1.

FIG. 3 is a circuit diagram illustrating a representation of an example of a power driving circuit according to an embodiment.

FIG. 4 is a conceptual diagram illustrating a representation of an example of the operations of a flag signal generation unit illustrated in FIG. 3.

FIG. 5 illustrates a block diagram of an example of a representation of a system employing a semiconductor device and/or a power driving circuit in accordance with the various embodiments discussed above with relation to FIGS. 1-4.

### DETAILED DESCRIPTION

Reference will now be made to various embodiments, examples of which are illustrated in the accompanying drawings. Wherever possible, the same reference numbers are used throughout the drawings to refer to the same or like portions. In the following description, a detailed description of related known configurations or functions incorporated herein may be omitted for clarity of the subject matter of the present disclosure.

Various embodiments may be directed to providing a power driving circuit and a semiconductor device including the same that substantially obviate one or more problems due to limitations and disadvantages of the related art.

The embodiments may relate to a technology for reducing unnecessary current consumption by operating a release circuit only when a voltage level of a voltage generation circuit is higher than a target level.

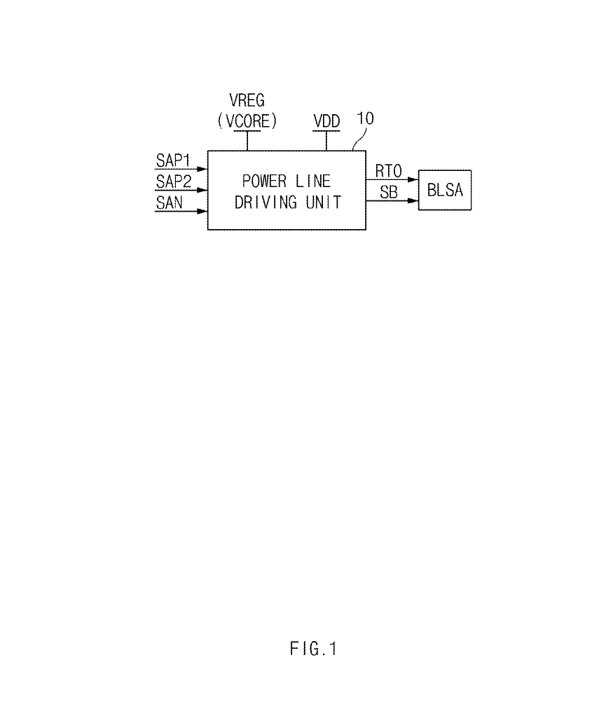

FIG. 1 is a block diagram illustrating a representation of an example of a semiconductor device to which a power driving circuit is applied according to an embodiment.

A memory device may generate a power-supply voltage needed for the memory device using an external power-supply voltage of less than a predetermined value, and may use the generated power-supply voltage. For example, in order to implement lower-power DRAMs as well as to reduce the influence of external power, an internal voltage having a potential lower than that of an external supply voltage may be used in a core region contained in the DRAM.

A memory device configured to use a bit line sense amplifier (BLSA) in the same manner as in a DRAM may use the core voltage (VCORE) to detect cell data. If a word line is activated, data of a plurality of memory cells coupled to the word line may be applied to the bit line. The bit line sense amplifier (BLSA) may detect a voltage difference of a pair of bit lines, and may amplify the detected voltage difference.

In order to store data in each DRAM cell, data may be applied to a bit line or an inverted bit line by the operation of the bit line sense amplifier (BLSA), so that a capacitor of a cell may be charged at a predetermined voltage level. This predetermined voltage level may be defined as a core voltage (VCORE) level.

An internal driver for generating the core voltage (VCORE) level may be referred to as a core voltage driver. With the increasing development of higher-speed DRAMs, it is necessary for each cell to be operated at higher speed. Due to the development of improved DRAMs designed to operate at higher speed, rapid charging capability is needed for the core voltage (VCORE) level of each cell.

Therefore, it may be necessary for the core voltage (VCORE) level to be set to a current peak value at which the bit line sense amplifier (BLSA) is operated. Accordingly, an over-driving method for allowing the core voltage (VCORE) level to be short-circuited with the external power-supply voltage (VDD) level having a higher potential is used.

For example, if a DRAM is driven, several thousand bit line sense amplifiers (BLSAs) are simultaneously operated. The BLSA driving time is determined according to whether it is possible to supply a sufficient amount of a current signal for driving several thousand BLSAs. However, since the operation voltage is gradually reduced in proportion to the increasing number of lower-power memory devices, it may be difficult to simultaneously provide the memory devices with a sufficient amount of a current signal.

In order to address this issue, an over-driving structure of the bit line sense amplifier (BLSA) may be used. For example, according to the over-driving structure of the bit line sense amplifier (BLSA), at the initial stage of the bit line sense amplifier (BLSA) operation (i.e., as soon as the cell and the bit line share charges with each other), a high voltage (power-supply voltage VDD) higher than a normal power-supply voltage (generally, internal core voltage VCORE) generally applied to a power line (RTO) of the bit line sense amplifier (BLSA) is instantaneously applied to the power line (RTO) of the bit line sense amplifier (BLSA).

The bit line sense amplifier (BLSA) may be coupled to one pair of bit lines. A power-supply signal may be applied to a power line (RTO) and a power line (SB) of the bit line sense amplifier (BLSA).

Generally, a core voltage (VCORE) may be applied to the power line (RTO). However, during the initial operation process, a power-supply voltage (VDD) higher than the core voltage (VCORE) may be applied to the power line driving unit to implement the faster sensing operation of the bit line sense amplifier (BLSA).

The power line driving unit 10 illustrated in FIG. 1 may activate the core voltage (VCORE) and the power-supply voltage (VDD) using drive control signals (SAP1, SAP2, SAN), and may output the activated core voltage (VCORE) and the activated power-supply voltage (VDD) to the power lines (RTO, SB) of the bit line sense amplifier (BLSA). The power line driving unit 10 may output the core voltage (VCORE) or the power-supply voltage (VDD) to a pull-up power line (RTO) upon receiving the drive control signals (SAP1, SAP2). The power line driving unit 10 may output a ground voltage to a pull-down power line (SB) upon receiving the drive control signal (SAN).

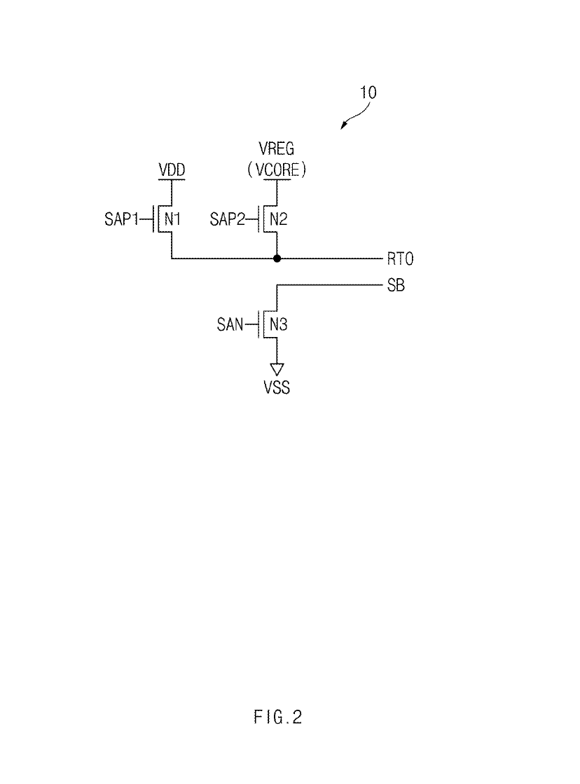

FIG. 2 is a circuit diagram illustrating a representation of an example of the power line driving unit 10 illustrated in FIG. 1.

Referring to FIG. 2, the power line driving unit 10 may include NMOS transistors (N1, N2). The NMOS transistors (N1, N2) may supply a pull-up voltage to the power line (RTO). The power line driving unit 10 may include an NMOS transistor N3 for supplying a pull-down voltage (i.e. ground voltage VSS) to the power line (SB).

In an example, the NMOS transistor N1 may be coupled between the power-supply voltage (VDD) input terminal and the power line (RTO), so that the NMOS transistor N1 receives the drive signal (SAP1) through a gate terminal. During the over-driving operation of the bit line sense amplifier (BLSA), the NMOS transistor N1 may be turned on by the drive signal (SAP1), so that the power-supply voltage (VDD) is applied to the power line (RTO).

The NMOS transistor N2 may be coupled between the core voltage (VCORE) input terminal and the power line (RTO), so that the NMOS transistor N2 receives the drive signal (SAP2) through a gate terminal. During the normal operation of the bit line sense amplifier (BLSA), the NMOS transistor N2 may be turned on by the drive signal (SAP2), so that the core voltage (VCORE) is applied to the power line (RTO).

The NMOS transistor N3 may be coupled between the ground voltage (VSS) input terminal and the power line (SB), so that the NMOS transistor N3 receives the drive signal (SAN) through a gate terminal. During the normal operation of the bit line sense amplifier (BLSA), the NMOS transistor N3 is turned on by the drive signal (SAN), so that the ground voltage (VSS) is applied to the power line (SB).

The core voltage (VCORE) may be used as a voltage for amplifying cell data, and, as such, it is very important to maintain the core voltage (VCORE) having a stable potential during the DRAM operation. However, since improved DRAMs designed to operate at higher speed and a lower voltage have recently been developed, external noise or the like is applied to the core voltage (VCORE), such that it may be difficult to implement a stable core voltage (VCORE).

When data is written in the cell, the core voltage (VCORE) greatly increases to the highest level. Therefore, when data is written in a DRAM, the consumption amount of the core voltage (VCORE) greatly increases such that the core voltage (VCORE) level is reduced. In order to address this issue, the over-driving scheme and the release driving scheme are applied to the power line (RTO) of the bit line sense amplifier (BLSA) to stabilize the core voltage (VCORE) level.

A description of the over-driving scheme is as follows. In order to increase the data sensing speed when the bit line sense amplifier (BLSA) is activated, the driving power of the bit line sense amplifier (BLSA) is dualized in a manner that the external power-supply voltage (VDD) is supplied to the power line (RTO) during a predetermined period of time, and the core voltage (VCORE) less than the external power-supply voltage (VDD) may then be supplied to the power line (RTO).

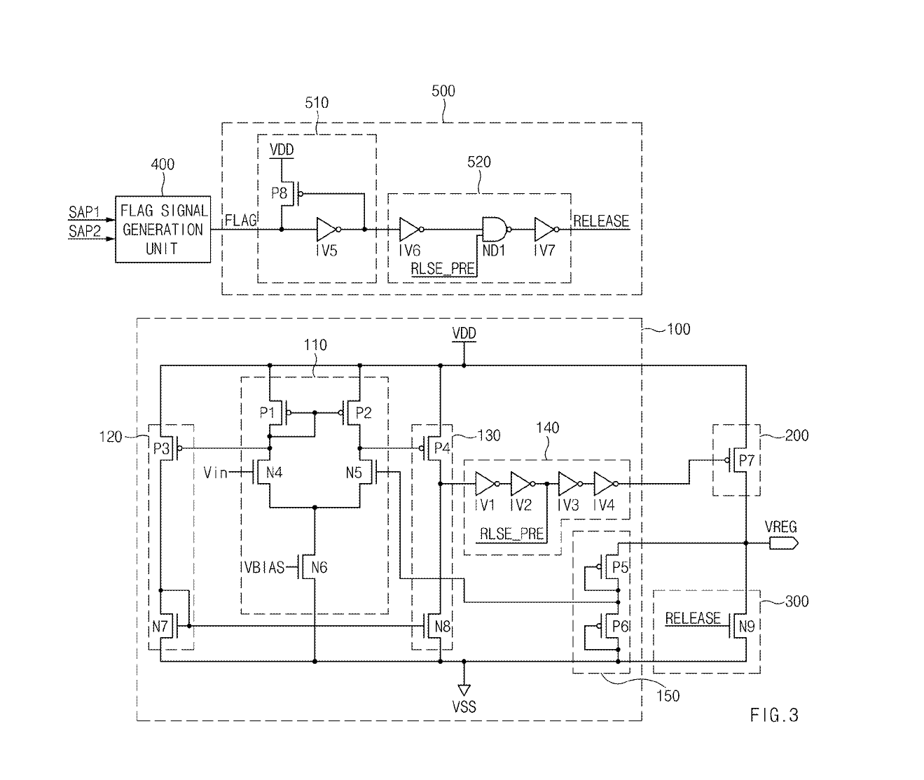

FIG. 3 is a circuit diagram illustrating a representation of an example of a power driving circuit according to an embodiment.

Referring to FIG. 3, the power driving circuit may include a voltage generation unit 100, a pull-up driving unit 200, and a release driving unit 300. The power driving circuit may include a flag signal generation unit 400, and a release controller 500. The voltage generation unit 100 may include a comparator 110, a biasing unit 120, and a driving unit 130. The voltage generation unit 100 may include a delay unit 140, and a voltage distribution unit 150.

The voltage generation unit 100 may generate an output voltage (VREG) and may output the output voltage (VREG) to the power line driving unit 10. In accordance with an embodiment, the output voltage (VREG) of the power driving circuit may be the core voltage (VCORE) level supplied to the power line driving unit 10.

The pull-up driving unit 200 may increase the output voltage (VREG) level of the voltage generation unit 100. The release driving unit 300 may reduce (or synchronize) the output voltage (VREG) level. The release driving unit 300 may reduce (or synchronize) the output voltage (VREG) level in response to a release signal (RELEASE).

The comparator 110 of the voltage generation unit 100 may compare the input signal (Vin) with the output signal of the voltage distribution unit 150. The comparator 110 of the voltage generation unit 100 may output the result of comparison to the driving unit 130. The comparator 110 may include PMOS transistors (P1, P2) and NMOS transistors (N4˜N6).

In an embodiment, a common gate terminal of the PMOS transistors (P1, P2) may be coupled to a drain terminal of the PMOS transistor P1. A common source terminal of the PMOS transistors (P1, P2) may be coupled to the power-supply voltage (VDD) input terminal. The NMOS transistor N4 may be coupled between the PMOS transistor P1 and the NMOS transistor N6, so that the NMOS transistor N4 receives the input signal (Vin) through a gate terminal. The NMOS transistor N5 may be coupled between the PMOS transistor P2 and the NMOS transistor N6, so that the NMOS transistor N5 receives the output signal of the voltage distribution unit 150 through a gate terminal.

The NMOS transistor N6 may be coupled between the ground voltage (VSS) input terminal and a common source terminal of the NMOS transistors (N4, N5), so that the NMOS transistor N6 receives a bias voltage (VBIAS) through a gate terminal. Therefore, the NMOS transistor N6 may always be turned on in response to the bias voltage (VBIAS), so that the NMOS transistor N6 provides a current path.

The biasing unit 120 may output the biasing voltage to the comparator 110. The biasing unit 120 may include a PMOS transistor P3 and an NMOS transistor N7. The PMOS transistor P3 and the NMOS transistor N7 may be coupled in series between the power-supply voltage (VDD) input terminal and the ground voltage (VSS) input terminal. A gate terminal of the PMOS transistor P3 may be coupled to a common drain terminal of the PMOS transistor P1 and the NMOS transistor N4. A gate terminal and a drain terminal of the NMOS transistor N7 are commonly coupled to each other.

The driving unit 130 may drive the output signal of the comparator 110, and may output the resultant signal to the delay unit 140. The driving unit 130 may include a PMOS transistor P4 and an NMOS transistor N8. The PMOS transistor P4 and the NMOS transistor N8 may be coupled in series between the power-supply voltage (VDD) input terminal and the ground voltage (VSS) input terminal. A gate terminal of the PMOS transistor P4 may be coupled to a common drain terminal of the PMOS transistor P2 and the NMOS transistor N5. A gate terminal of the NMOS transistor N8 may be commonly coupled to the NMOS transistor N7.

The delay unit 140 may delay the output signal of the driving unit 130 for a predetermined period of time, and then may output the delayed output signal to the pull-up driving unit 200. The delay unit 140 may include a plurality of inverters (IV1˜IV4) coupled to each other in series. The inverters (IV1, IV2) may not invert the output signal of the driving unit 130, and may delay the output signal of the driving unit 130, so that a release control signal (RLSE_PRE) may be output to the release controller 500. The inverters (IV3, IV4) may not invert the release control signal (RLSE_PRE), and may delay the release control signal (RLSE_PRE), so that the delayed signal may be output to the pull-up driving unit 200.

The voltage distribution unit 150 may perform voltage distribution of the output voltage (VREG), and may output the distribution result to the comparator 110. The voltage distribution unit 150 may include PMOS transistors (P5, P6) coupled in series between the output voltage (VREG) output terminal and the ground voltage (VSS) input terminal. A common connection terminal of the PMOS transistors (P5, P6) may be coupled to a gate terminal of the NMOS transistor N5. A gate terminal and a drain terminal of the PMOS transistor P5 may be commonly coupled to each other. A gate terminal and a drain terminal of the PMOS transistor P6 may be commonly coupled to each other. For example, the voltage distribution unit 150 may output a distribution voltage having a voltage level of ½ of the output voltage (VREG).

Example operations of the above-mentioned voltage generation unit 100 may be as follows.

The voltage distribution unit 150 may output a distribution voltage to the comparator 110. The comparator compares a voltage of the input signal (Vin) with a distribution voltage of the voltage distribution unit 150, and may output the result of comparison to the driving unit 130. The driving capability of the NMOS transistors (N4, N5) may be changed in response to the input signal (Vin) voltage and the distribution voltage of the voltage distribution unit 150, so that voltage values of both output nodes of the comparator 110 are changed.

For example, if the external power-supply voltage (VDD) is reduced, the output signal of the driving unit 130 is at a low level. Accordingly, the pull-up driving unit 200 may be turned on so that the output voltage (VREG) level increases. On the other hand, if the external power-supply voltage (VDD) increases, the output signal of the driving unit 130 is at a high level, so that the pull-up driving unit 200 is turned off. In this example, the output voltage (VREG) level is no longer increased.

The pull-up driving unit 200 may include a PMOS transistor P7. The PMOS transistor P7 may be coupled between the power-supply voltage (VDD) input terminal and the output voltage (VREG) output terminal, so that a gate terminal of the PMOS transistor P7 is coupled to an inverter IV4. If the output signal of the delay unit 140 is at a low level, the PMOS transistor P7 of the pull-up driving unit 200 may be turned on so that the output voltage (VREG) level increases.

The release driving unit 300 may include an NMOS transistor N9. The NMOS transistor N9 may be coupled between the output voltage (VREG) output terminal and the ground voltage (VSS) input terminal, so that the NMOS transistor N9 receives the release signal (RELEASE) through a gate terminal. The NMOS transistor N9 of the release driving unit 300 may be turned on during a predetermined time in which the release signal (RELEASE) is activated to a high level, so that the NMOS transistor N9 reduces the output voltage (VREG) level. The release driving unit 300 may compensate for the amount of current flowing from the external power-supply voltage (VDD) input terminal to the core voltage (VCORE) input terminal due to the over-driving operation.

Therefore, according to an embodiment, the pull-up driving unit 200 and the release driving unit 300 may be operated in a complementary manner in response to the power-supply voltage (VDD) level, so that the output voltage (VCORE) can be stabilized.

The flag signal generation unit 400 may generate a flag signal (FLAG) in response to a combination of the drive signals (SAP1, SAP2). The release controller 500 may operate the release driving unit 300 during a predetermined time in which the flag signal (FLAG) is activated to, for example, a high level.

An embodiment has disclosed, for example, that the flag signal generation unit 400 may be controlled by the drive signals (SAP1, SAP2). However, the scope or spirit of the embodiments are not limited thereto, the flag signal (FLAG) may also be controlled according to a system temperature. If a rapid power supply is needed as in the power-up operation, the pull-up driving unit 200 may first be turned on so that the pull-up driving unit 200 may also control the supply of current irrespective of a reference level.

The release controller 500 may include a latch unit 510 and a combination unit 520.

The latch unit 510 may latch the flag signal (FLAG) for a predetermined time. In an embodiment, the latch unit 510 may include a PMOS transistor P8 and an inverter IV5. If the flag signal (FLAG) is at, for example, a high level, the inverter IV5 may invert the flag signal (FLAG) level, so that a low-level flag signal (FLAG) is output to the PMOS transistor P8. Since the PMOS transistor P8 is turned on, the flag signal (FLAG) may be pulled up to the power-supply voltage (VDD) level.

The combination unit 520 may combine the output signal of the latch unit 510 with the release control signal (RLSE_PRE), and may output the release signal (RELEASE). The combination unit 520 may include a logic gate, for example but not limited to, a NAND gate ND1 and inverters (IV6, IV7). The inverter IV6 may invert the low-level signal so that the inverter IV6 may output, for example, a high-level signal to the NAND gate ND1. The NAND gate ND1 may combine an output signal of the inverter IV6 with the release control signal (RLSE_PRE), and may output the combination result to the inverter IV7.

For example, if the release control signal (RLSE_PRE) is at a high level, the combination unit 520 may output the release signal (RELEASE) of a high level. As a result, the release driving unit 300 is operated in response to the release signal (RELEASE). On the other hand, if the release control signal (RLSE_PRE) is at a low level, the combination unit 520 outputs the release signal (RELEASE) of a low level. As a result, the release driving unit 300 stops operation so that a sink operation is not performed, resulting in cut-off of an unnecessary current path.

That is, the flag signal (FLAG) may be activated to a high level during only a predetermined section starting from a specific time at which power supply of the power line driving unit 100 is switched from the power-supply voltage (VDD) level to the core voltage (VCORE) level. Therefore, the release driving unit 300 can only be operated during a predetermined section in which the flag signal (FLAG) is at a high level and the release control signal (RLSE_PRE) is activated to a high level. In contrast, if the flag signal (FLAG) transitions to a low level, the latch unit 510 may reset so that the release driving unit 300 stops operation.

As a result, the release driving unit 300 may be prevented from being excessively operated, resulting in reduction of unnecessary current consumption. A leakage current path generated from the output voltage (VREG) stage can be cut off. In addition, it may prevent the core voltage (VCORE) level from increasing due to the over-driving operation of the bit line sense amplifier (BLSA).

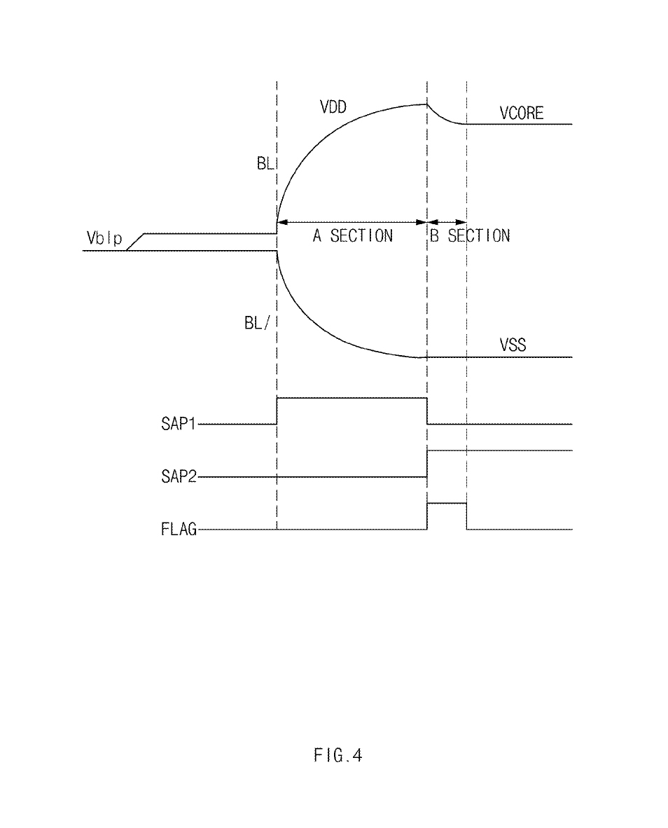

FIG. 4 is a conceptual diagram illustrating a representation of an example of the operations of the flag signal generation unit 400 illustrated in FIG. 3.

Referring to FIG. 4, a bit line (i.e. BL or BL/) may be precharged to a bit line precharge voltage Vblp level during the driving signal (SAP1) is a low level. If a specific word line (not illustrated) is activated, several cell transistors, each of which use the activated word line as an input signal, are operated, so that the bit line sense amplifier (BLSA) allows data of several memory cells coupled to the word line to be applied to a bit line.

In this example, if the drive signal (SAP1) is activated for the over-driving operation section (A section) of the bit line sense amplifier (BLSA), the NMOS transistor N1 is turned on. Thereafter, the NMOS transistor N3 is turned on by the drive signal (SAN). As a result, the power-supply voltage (VDD) may be applied to the power line (RTO) of the bit line sense amplifier (BLSA) and the ground voltage (VSS) may be applied to the power line (SB).

As described above, if a power-supply signal is applied to the power lines (RTO, SB) of the bit line sense amplifier (BLSA), the bit line sense amplifier (BLSA) may detect a voltage difference of a pair of bit lines, and amplify the detected voltage difference.

If the pair of bit lines are developed to a predetermined level due to the BLSA operation, a power source may be switched to the core voltage (VCORE) indicating a stable constant voltage source. Therefore, if the over-driving operation is completed, the drive signal (SAP1) may transition to a low level. In the example of the normal driving operation, if the drive signal (SAP2) transitions to a high level, the NMOS transistor N2 may be turned on so that the power line (RTO) has the core voltage (VCORE) level.

The power line driving unit 10 may be configured in a manner that the NMOS transistor N2 disposed between the core voltage (VCORE) input terminal and the power line (RTO) is short-circuited. Therefore, since charges caused by the power-supply voltage (VDD) move from the power line (RTO) to the core voltage (VCORE), the core voltage (VCORE) level may increase during the section B. As a result, the core voltage (VCORE) may increase in a high-level power-supply voltage (VDD).

Therefore, the release driving unit 300 may discharge charges received from the power line (RTO) toward a ground terminal to prevent the core voltage (VCORE) from increasing. However, if the core voltage (VCORE) approximates a target level, the voltage generation unit 100 and the release driving unit 300 may be continuously operated in a complementary manner, resulting in a large amount of current consumption.

Therefore, according to an embodiment, the release driving unit 300 may be driven during only the B section in which the power-supply voltage (VDD) level is switched to the core voltage (VCORE) level, resulting in reduction of unnecessary current consumption.

That is, the flag signal generation unit 400 may generate the flag signal (FLAG) for operating the release driving unit 300 during only a predetermined section (i.e., B section) in which the drive signal (SAP1) transitions to a low level and the drive signal (SAP2) transitions to a high level. The flag signal generation unit 400 may combine the drive signal (SAP1) with the drive signal (SAP2), so that the flag signal (FLAG) is activated to a high level during only a predetermined section (B section) in which a power level is changed.

As is apparent from the above descriptions, the various embodiments may reduce unnecessary current consumption by operating a release circuit only when a voltage level of a voltage generation circuit is higher than a target level.

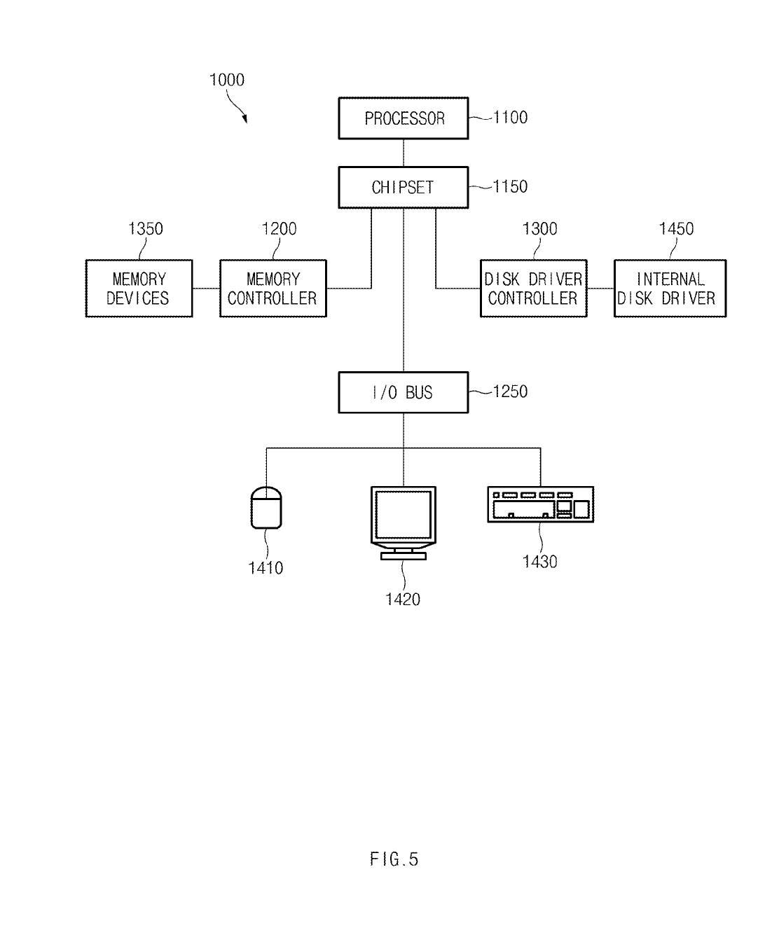

The semiconductor devices and/or a power driving circuits discussed above (see FIGS. 1-4) are particular useful in the design of memory devices, processors, and computer systems. For example, referring to FIG. 5, a block diagram of a system employing a semiconductor device and/or a power driving circuit in accordance with the various embodiments are illustrated and generally designated by a reference numeral 1000. The system 1000 may include one or more processors (i.e., Processor) or, for example but not limited to, central processing units (“CPUs”) 1100. The processor (i.e., CPU) 1100 may be used individually or in combination with other processors (i.e., CPUs). While the processor (i.e., CPU) 1100 will be referred to primarily in the singular, it will be understood by those skilled in the art that a system 1000 with any number of physical or logical processors (i.e., CPUs) may be implemented.

A chipset 1150 may be operably coupled to the CPU 1100. The chipset 1150 is a communication pathway for signals between the processor (i.e., CPU) 1100 and other components of the system 1000. Other components of the system 1000 may include a memory controller 1200, an input/output (“I/O”) bus 1250, and a disk driver controller 1300. Depending on the configuration of the system 1000, any one of a number of different signals may be transmitted through the chipset 1150, and those skilled in the art will appreciate that the routing of the signals throughout the system 1000 can be readily adjusted without changing the underlying nature of the system 1000.

As stated above, the memory controller 1200 may be operably coupled to the chipset 1150. The memory controller 1200 may include at least one semiconductor device and/or a power driving circuit as discussed above with reference to FIGS. 1-4. Thus, the memory controller 1200 can receive a request provided from the processor (i.e., CPU) 1100, through the chipset 1150. In alternate embodiments, the memory controller 1200 may be integrated into the chipset 1150. The memory controller 1200 may be operably coupled to one or more memory devices 1350. In an embodiment, the memory devices 1350 may include the at least one semiconductor device and/or a power driving circuit as discussed above with relation to FIGS. 1-4, the memory devices 1350 may include a plurality of word lines and a plurality of bit lines for defining a plurality of memory cells. The memory devices 1350 may be any one of a number of industry standard memory types, including but not limited to, single inline memory modules (“SIMMs”) and dual inline memory modules (“DIMMs”). Further, the memory devices 1350 may facilitate the safe removal of the external data storage devices by storing both instructions and data.

The chipset 1150 may also be coupled to the I/O bus 1250. The I/O bus 1250 may serve as a communication pathway for signals from the chipset 1150 to I/O devices 1410, 1420, and 1430. The I/O devices 1410, 1420, and 1430 may include, for example but are not limited to, a mouse 1410, a video display 1420, or a keyboard 1430. The I/O bus 1250 may employ any one of a number of communications protocols to communicate with the I/O devices 1410, 1420, and 1430. Further, the I/O bus 1250 may be integrated into the chipset 1150.

The disk driver controller 1300 may be operably coupled to the chipset 1150. The disk driver controller 1300 may serve as the communication pathway between the chipset 1150 and one internal disk driver 1450 or more than one internal disk driver 1450. The internal disk driver 1450 may facilitate disconnection of the external data storage devices by storing both instructions and data. The disk driver controller 1300 and the internal disk driver 1450 may communicate with each other or with the chipset 1150 using virtually any type of communication protocol, including, for example but not limited to, all of those mentioned above with regard to the I/O bus 1250.

It is important to note that the system 1000 described above in relation to FIG. 5 is merely one example of a system 1000 employing a semiconductor device and/or a power driving circuit as discussed above with relation to FIGS. 1-4. In alternate embodiments, such as cellular phones or digital cameras, the components may differ from the embodiments illustrated in FIG. 5.

Those skilled in the art will appreciate that the embodiments may be carried out in other specific ways than those set forth herein without departing from the spirit and essential characteristics of the description. The above embodiments are therefore to be construed in all aspects as illustrative and not restrictive. All changes coming within the meaning and equivalency range of the appended claims are intended to be embraced therein. In addition, it is obvious to those skilled in the art that claims that are not explicitly cited in each other in the appended claims may be presented in combination as an embodiment or included as a new claim by a subsequent amendment after the application is filed.

Although a number of illustrative embodiments consistent with the description have been described, it should be understood that numerous other modifications and embodiments can be devised by those skilled in the art that will fall within the spirit and scope of the principles of this disclosure. Particularly, numerous variations and modifications are possible in the component parts and/or arrangements which are within the scope of the disclosure, the drawings and the accompanying claims. In addition to variations and modifications in the component parts and/or arrangements, alternative uses will also be apparent to those skilled in the art.

What is claimed is:

1. A power driving circuit comprising:
a voltage generation unit configured to generate a release control signal and an output voltage;
a release controller configured to enable a release signal during an activation section of a flag signal in response to the release control signal;
a pull-up driving unit configured to increase a level of the output voltage in response to the release control signal; and
a release driving unit configured to synchronize a level of the output voltage in response to the release signal.

2. The power driving circuit according to claim 1, wherein the voltage generation unit includes:
a comparator configured to compare a voltage of an input signal with a distribution voltage when a bias voltage is activated;
a biasing unit configured to provide the comparator with a biasing voltage;
a driving unit configured to drive an output signal of the comparator;
a delay unit configured to control an operation of the pull-up driving unit by delaying an output signal of the driving unit and outputs the release control signal by delaying the output signal of the driving unit for a predetermined time; and
a voltage distribution unit configured to distribute the output voltage, and output the distribution voltage.

3. The power driving circuit according to claim 2, wherein the voltage distribution unit outputs the distribution voltage having a voltage level of half of the output voltage.

4. The power driving circuit according to claim 1, wherein the release controller includes:
a latch unit configured to latch the flag signal; and
a combination unit configured to combine an output signal of the latch unit with the release control signal, and output the release signal.

5. The power driving circuit according to claim 4, wherein the latch unit outputs a low-level signal to the combination unit when the flag signal is at a high level.

6. The power driving circuit according to claim 4, wherein the latch unit includes:
a first inverter configured to invert the flag signal; and
a PMOS transistor coupled between a power-supply voltage input terminal and an input terminal of the flag signal, configured to receive an output signal of the first inverter through a gate terminal.

7. The power driving circuit according to claim 4, wherein the combination unit activates the release signal to a high level when the flag signal is at a high level and the release control signal is at a high level.

8. The power driving circuit according to claim 4, wherein the combination unit includes:
a second inverter configured to invert the output signal of the latch unit;
a NAND gate configured to perform a NAND operation between the release control signal and the output signal of the second inverter; and
a third inverter configured to invert an output signal of the NAND gate, and output the release signal.

9. The power driving circuit according to claim 1, wherein the pull-up driving unit includes:
a PMOS transistor configured to apply a power-supply voltage to an output terminal of the output voltage in response to an output signal of the voltage generation unit.

10. The power driving circuit according to claim 1, wherein the release driving unit includes:
an NMOS transistor configured to apply a ground voltage to an output terminal of the output voltage in response to the release signal.

11. The power driving circuit according to claim 1, further comprising:
a flag signal generation unit configured to generate the flag signal in response to a first drive signal and a second drive signal.

12. The power driving circuit according to claim 11, wherein the first drive signal is a control signal for supplying a power-supply voltage to a first power line of a bit line sense amplifier (BLSA).

13. The power driving circuit according to claim 11,
wherein the second drive signal is a control signal for supplying the output voltage to a second power line of a bit line sense amplifier (BLSA), and
wherein the output voltage is a core voltage.

14. The power driving circuit according to claim 11, wherein the flag signal generation unit activates the flag signal during a predetermined period starting from a specific time corresponding to when the first drive signal is deactivated and the second drive signal is activated.

15. The power driving circuit according to claim 11,
wherein the first drive signal is activated during an over-driving operation section of a bit line sense amplifier (BLSA).
wherein the second drive signal is activated during a normal operation section of a bit line sense amplifier (BLSA).

16. The power driving circuit according to claim 1, further comprising:
a flag signal generation unit configured to generate the flag signal in response to a system temperature.

17. The power driving circuit according to claim 1, wherein the flag signal is activated during a predetermined period starting from a specific time corresponding to when a first power source is switched to a second power source.

18. A semiconductor device comprising:
a power driving circuit configured to generate a core voltage in response to a power-supply voltage level, and synchronize the core voltage in response to a release signal activated during an activation time of a flag signal;
a power line driving unit configured to selectively supply the power-supply voltage or the core voltage to a first power line in response to a drive signal, and supply a ground voltage to a second power line; and
a bit line sense amplifier coupled to the first power line and the second power line, and configured to amplify cell data received from a bit line.

19. The semiconductor device according to claim 18, wherein the power driving circuit includes:
a voltage generation unit configured to generate a release control signal and the core voltage;
a release controller configured to enable the release signal during an activation section of the flag signal in response to the release control signal;
a pull-up driving unit configured to increase a level of the core voltage in response to the release control signal; and
a release driving unit configured to synchronize a level of the core voltage in response to the release signal.

20. The semiconductor device according to claim 18, wherein the power driving circuit further includes:
a flag signal generation unit configured to generate the flag signal in response to a first drive signal for controlling an over-driving operation and a second drive signal for controlling a normal operation.
